(19) United States
(12) Patent Application Publication
(10) Pub. No.: US 2013/0205934 A1
(43) Pub. Date: Aug. 15, 2013

(54) AGRICULTURAL WORKING MACHINE

(71) Applicant: CLAAS SELBSTFAHRENDE ERNTEMASCHINEN GMBH, (US)

(72) Inventors: Ingo Schwenk, Guetersloh (DE); Henning Harenkamp, Sassenberg (DE)

(73) Assignee: CLAAS SELBSTFAHRENDE ERNTEMASCHINEN GMBH, Harsewinkel (DE)

(21) Appl. No.: 13/765,125

(22) Filed: Feb. 12, 2013

(30) Foreign Application Priority Data
Feb. 15, 2012 (DE) 102012002992.6

(51) Int. Cl. G05G 1/04

(52) U.S. Cl. CPC G05G 1/04
USPC 74/494; 74/491

(57) ABSTRACT

An agricultural working vehicle includes a working tool, a drive assembly for raising and lowering the working tool and a control element that is deflected from a neutral position in different directions. A speed (v) at which the drive assembly moves the working tool is a continuous function of a deflection (a) of the control element.

### CROSS-REFERENCE TO A RELATED APPLICATION

The invention described and claimed hereinbelow is also described in German Patent Application DE 10 2012 002992.6, filed on Feb. 15, 2012. This German Patent Application, subject matter of which is incorporated herein by reference, provides the basis for a claim of priority of invention under 35 U.S.C. 119(a)-(d).

### BACKGROUND OF THE INVENTION

The invention broadly relates to an agricultural working vehicle such as a forage harvester or a combine harvester.

The working tools of conventional agricultural working vehicles such as forage or combine harvesters are generally removable, whether to replace the working tool in order to adapt to work to be performed or because the dimensions of the working tool are so great that the working vehicle, with the working tool mounted thereon, is prohibited from traveling on public roads. In that case, the working tool must be delivered separately, e.g., on a trailer drawn by the working vehicle, to the site of use, where it must be lifted.

The raising and lowering of a working tool requires a great deal of caution and practice on the part of a user. Mistakes can result in damage to the working tool, which are costly to repair.

In order to control a drive assembly for raising or lowering the working tool, a conventional working tool comprises a toggle switch that is movable in two degrees of freedom. By swiveling the toggle switch in a first degree of freedom, the driver can select whether to raise or lower the working tool. By swiveling the toggle switch in the second degree of freedom, the driver sets the speed of the motion. In order to lift a working tool, a driver will generally drive the working vehicle toward the working tool with a greatly lowered, vehicle-side coupling and then raise the coupling at the slow speed for engagement thereof with a tool-side coupling. The further the vehicle-side coupling is lowered and the more slowly it is raised, the more certain it is that damage to the working tool will be prevented; however, it takes that much longer to raise the tool.

An agricultural working tool comprising a such multifunctional handle, the diverse control elements of which facilitate such control of a working tool, is known from DE 10 2009 034 154 A1.

### SUMMARY OF THE INVENTION

The present invention overcomes the shortcomings of known arts, such as those mentioned above.

In an embodiment, the invention provides an agricultural working tool that permits working tools to be handled rapidly as well as safely.

In an embodiment, the invention provides a working tool, a drive assembly for raising and lowering the working tool and a control element that can be deflected from a neutral position in different directions in order to control the drive assembly. The speed at which the drive assembly moves the working tool is a continuous function of the deflection of the control element. This feature makes it possible for the user to flexibly adapt the speed of the drive assembly to the extent of the danger and, when setting down the working tool (e.g., to thereby lower the working tool rapidly at first), provided it is not close to a surface underneath and to reduce the speed upon approaching the surface underneath, in order to ultimately place the tool onto the surface underneath gently and safely.

The speed is preferably controlled by deflecting the control element via rotation about an axis.

To ensure safe handling, it is advantageous for the control element to have a corrugated circumferential surface.

The axis about which the control element can be rotated is preferably oriented transversely to the direction of travel of the working tool so that, upon deflection, the circumferential surface of the control element is moved vertically or in the direction of travel, but not in the direction transverse to the vehicle. This makes it possible, even for an untrained user, to establish a logical connection between the direction of the deflection and the direction of the tool motion and to prevent the tool from inadvertently moving in the wrong, undesired direction.

If only a portion of the surface of the control element is exposed and the rest is inaccessible, e.g., in a housing, then the exposed surface is preferably oriented such that deflection of the surface upwardly and/or in the direction of travel permits the working tool to be raised. Deflection thereof opposite the direction of travel and/or downward permits the working tool to be lowered. Thus, easy accessibility and convenient operability of the surface can be combined with a correlation, which is clearly intuitive to the user, between the direction of the deflection and the direction of the resultant tool motion.

The control element is preferably disposed on a multifunctional handle along with control elements for other functions of the working vehicle.

Such a multifunctional triol can have a gripping surface that is oriented to support at least a portion of the palm of a user's hand lying in an operating position and thereby permit operation for a long period of time without the operator becoming tired. The control element is placed on the multifunctional handle in order to reach the control element by a finger on the hand lying in the operating position.

A surface of the multifunctional handle adjoins the exposed surface of the control element in a flush manner, preferably transversely to the deflection direction. Such a surface shape help prevents inadvertent deflection of the control element.

To ensure that inadvertent, light contact with the control element does not result in unwanted movement of the tool, the control element is configured to be fixed in the neutral position by way of locking means.

The position of the working tool being influenced by accidental, small deflections of the control element also can be prevented in that an interval of the deflection, in which the speed of the working tool is zero, extends on either side of the neutral position. The tool, therefore, does not begin to move until the control element is deflected out of said interval.

Further features and advantages of the invention will become apparent from the description of embodiments that follows, with reference to the attached figures, wherein

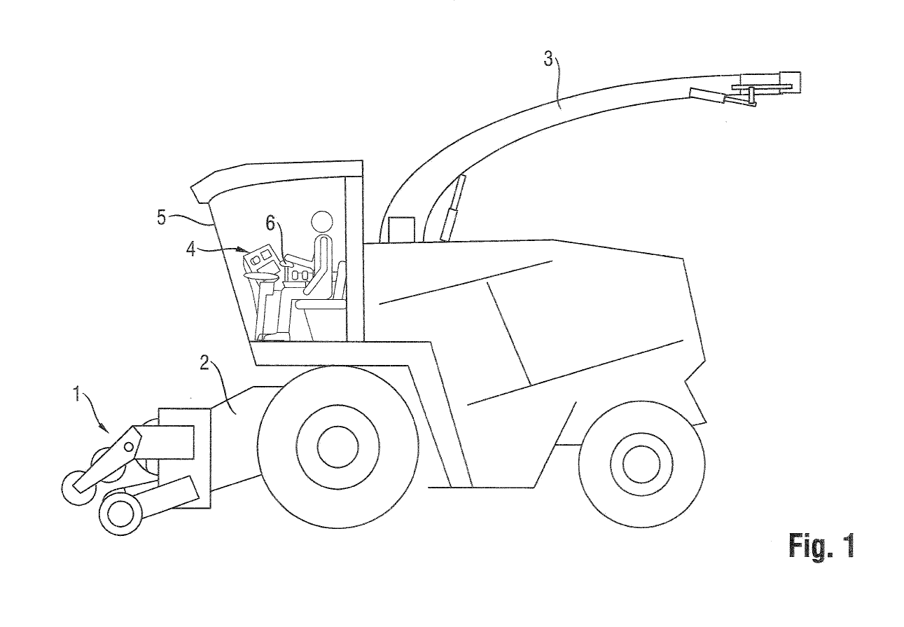

FIG. 1 shows a schematic view of a forage harvester as an example of an agricultural vehicle according to the invention;

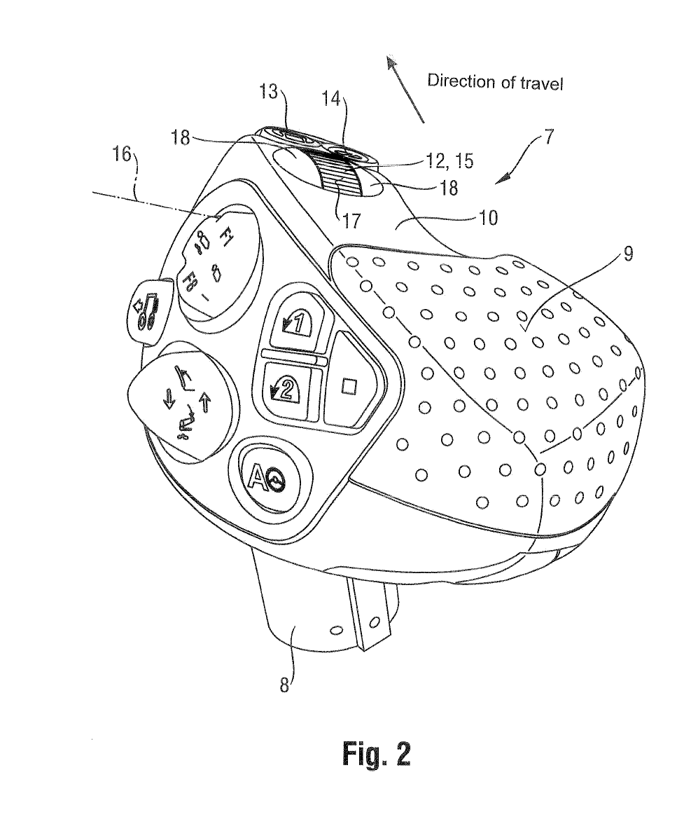

FIG. 2 shows a view of the head of a multifunctional handle used in the forage harvester depicted in FIG. 1;

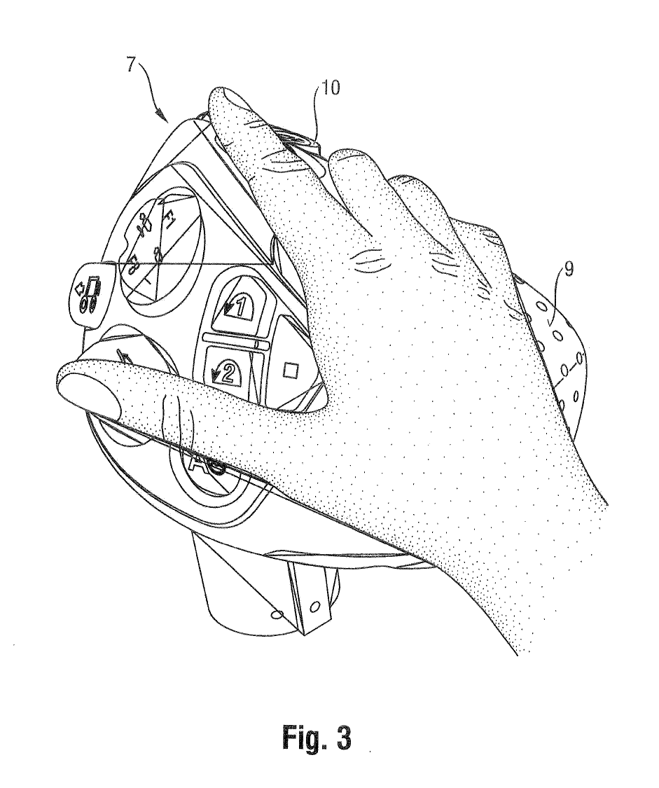

FIG. 3 shows the head with a driver's hand resting thereon;

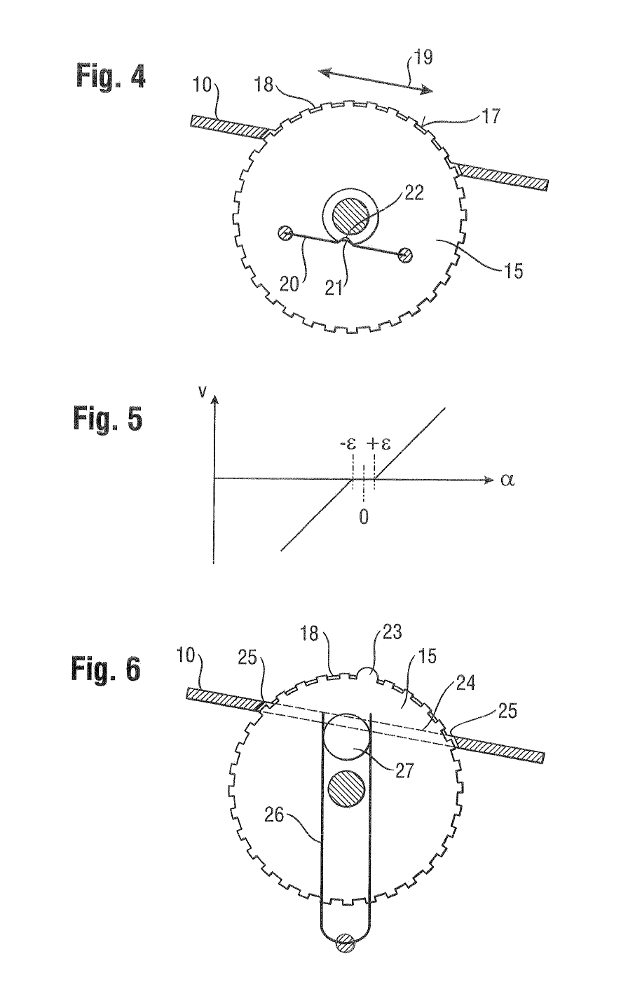

FIG. 4 shows a control element of the multifunctional handle;

FIG. 5 shows a graph that illustrates the correlation between the deflection of the control element and the raising and lowering speed of the tool of the forage harvester;

FIG. 6 shows a variant of the control element; and

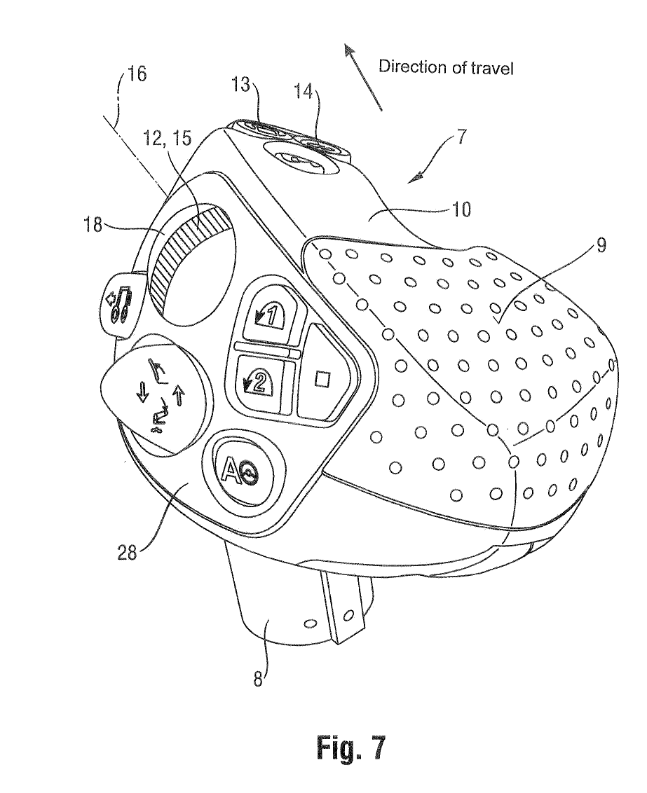

FIG. 7 shows a perspective view of the head of a multifunctional handle according to a second embodiment;

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

A person skilled in the art is familiar with the basic features of the forage harvester, such as the forest harvester depicted in FIG. 1. Hence, this disclosure does not describe in detail known assemblies used in conventional harvesting machines, such as front harvesting attachment 1, intake assembly 2, chopping mechanism, and transfer bend 3. What is important for an understanding of the present invention is that the front harvesting attachment 1 is removable for transport on a trailer on a public road, and permits selection and installation of the appropriate front harvesting attachment for the particular crop to be harvested. In order to remove the front harvesting attachment 1 from a non-illustrated trailer, for example, or to lower said front harvesting attachment onto said trailer after use, the height of the intake assembly 2 is adjusted with the aid of hydraulic cylinders that are driveable by a diesel engine of the forage harvester via a pump having a variable throughput rate.

Control elements for controlling various functions, in particular for adjusting the height of the intake assembly 2, are disposed in an instrument panel 4 of a driver's cab 5 and are situated there on a multifunctional handle 6. The multifunctional handle 6 is displaceable relative to the instrument panel 4 to control the progressive motion of the forage harvester. The multifunctional handle can have a single degree of freedom for displacement, for controlling forward and reverse motions of the forage harvester, e.g., in the form of a gate guide of the type described in U.S. Pat. No. 6,715,269 B2. Preferably, however, the multifunctional handle 6 has two degrees of freedom for displacement, one in the direction of travel for controlling the forward and reverse motion and ground speed, and one in the direction transverse to the vehicle for controlling the direction of travel.

The use of the multifunctional handle 6, described in greater detail in the following, is not limited to a forage harvester, however, and may be used for any other type of agricultural vehicle such as a tractor or a combine harvester.

FIG. 2 shows a perspective view of the head of the multifunctional handle, as viewed by the driver. A hollow neck 8 is integrally formed on the underside of the grip head 7, and accommodates a shaft of the handle (which is not shown in FIG. 2) and connects the head 7 to a joint in the instrument panel 4. The grip head 7 is irregularly shaped. Consequently, sides of the grip head are not sharply delineated from each other and instead transition continuously into each other at edges that are rounded off to a greater or lesser extent. Yet, a continuous surface is identifiable that is curved relatively slightly, is disposed on a top side that is approximately diametrically opposed to the neck 8 and that includes a gripping surface 9 in the region thereof facing the driver that is adapted to the shape and size of a driver's palm. And, adjacent thereto in the direction of travel, the continuous surface includes a control field 10. As shown in FIG. 2, the gripping surface 9 has small recesses distributed thereon.

While the gripping surface 9 is sized to support the metacarpal bones of the second to fifth fingers along the entire length thereof, the width of the control field 10 is designed only for the index and middle fingers. Therefore, the remaining fingers can grip a steeply slanted flank 11 on a side of the grip head 7 that faces away from the driver and not shown in FIG. 2. And, the driver can pull the grip head 7 toward himself using the fingers, even if the index and middle fingers are substantially extended on the control field 10 and are unable to pull.

In the FIG. 2 embodiment, the control field 10 comprises three control elements 12, 13, 14. The control element 12 adjusts the height of the intake assembly 2 and the front harvesting attachment 1; but the control elements 13, 14 can be dedicated to other functions of the front harvesting attachment 1. The two control elements, 13 and 14, are placed on the front end of the control field 10 such that, when the driver's hand rests on the gripping surface 9 (FIG. 3) and the index finger is extended, the tip thereof can touch one of the two control elements 13, 14 (which are designed as buttons), and depress them. The control element 12 is located closer on the gripping surface 9, and therefore, the user must curve the index finger in order to touch and deflect said control element using the fingertip.

The control element 12 comprises a knurled wheel 15 having a flat, cylindrical shape. The wheel can be rotated about an axis 16 extending substantially through the grip head 7 transversely to the direction of travel of the forage harvester. The greatest portion of the knurled wheel 15 is housed in the grip head 7. An exposed part of the circumferential surface 17 thereof is elongated on both sides in the direction of the axis 16 via arched housing segments 18 of the grip head 7. The housing segments 18, therefore, together with the exposed circumferential surface 17, form a substantially flat, lenticular projection on the control field 10.

FIG. 4 shows the knurled wheel 15 in a schematic side view in the direction of the axis 16. The control field 10, into which the knurled wheel 15 extends, rises slightly in the direction of travel, i.e. toward the left in FIG. 4. In order to turn the knurled wheel 15, therefore, the user's finger (which is in contact with the exposed circumferential surface 17), must make a motion in the direction of a double arrow labeled with reference numeral 19 in the figure. That is, the point on the circumferential surface 17 contacted by the driver's fingertip is deflected substantially in the direction of travel and, simultaneously, slightly upward, or is deflected opposite the direction of travel and slightly downward. It is understood to be clearly intuitive to the driver that deflection in the direction of travel triggers an upward motion of the intake assembly 2, and motion opposite the direction of travel triggers a downward motion.

To ensure that accidental contact of the circumferential surface 17 does not result in deflection and, therefore, a change in height of the intake assembly 2, the knurled wheel 15 is locked in the neutral position thereof. Such locking can be accomplished with the aid of a leaf spring 20. In this case, the ends of said leaf spring are fixed in the grip head 7, the leaf spring comprising an elastically deflectable projection 21, which engages in a notch 22 of the knurled wheel 15 when in the neutral position.

In order to convert the position of the knurled wheel 15 into a signal that can be used to control the speed of the intake assembly 2, a potentiometer is coupled to the knurled wheel 15. By way of the design thereof, such a potentiometer generally limits the freedom of rotational motion of the knurled wheel 15 to approximately half of one revolution. By way thereof, a linear correlation between the deflection of the control element 13 and the displacement speed of the intake assembly 2 can be easily achieved.

The invention further contemplates use a digital angle-of-rotation sensor that converts rotation of the knurled wheel 15 into a pulse train comprising a number of pulses that is proportional to the angle of rotation that was passed through. Such an angle-of-rotation sensor is particularly suitable for attaining any type of interrelationship between the deflection α of the control element 13 and the displacement speed v of the intake assembly. That approximate interrelationship is shown as a solid curve in FIG. 5, in which small deflections about the neutral position 0 do not result in motion and only those deflections that exceed a threshold +ε or −ε result in a displacement speed v that increases linearly depending on the deflection α.

Alternatively, a displacement speed that increases faster than linearly depending on the deflection can be implemented. Doing so makes it possible to precisely regulate a slow displacement speed and achieve rapid displacement via moderate deflection.

Such a digital angle-of-rotation sensor does not necessarily limit the freedom of rotational motion of the knurled wheel 15, and so it is basically possible to rotate the knurled wheel 15 to any extent, even by more than one revolution, toward the neutral position. In order to ensure that the driver can quickly return to the neutral position at any time, it is advantageous to limit the freedom of rotational motion of the knurled wheel 15. A projection 23 of the knurled wheel 15 can be used for this purpose. For example (as shown in FIG. 6), the projection is located in the neutral position centrally in the window 24 of the control field 10 filled by the knurled wheel 15 and is deflectable from there in the direction of travel or opposite the direction of travel until said projection impacts a front or rear edge 25 of the window 24.

As long as the user's fingertip is touching the projection 23, the user can gauge the intensity and direction of the deflection without having to look at the control field 10. The operator therefore always knows how he/she must move the control element 15 in order to stop the intake assembly 2. In this embodiment, the knurled wheel 15 need not be circular; it is sufficient to provide a segment of a circle having a circumferential surface that is long enough to fill the window 24 in any reachable position.

To enable the drive assembly to be stopped rapidly in an emergency, a return spring is dedicated to the knurled wheel 15 (FIG. 6). The return spring is in the form of a hairpin spring 26 in this case. The two legs of the spring are immobilized in the head 7 at the interconnected ends thereof, and the free ends of which rest on either side of a peg 27 protruding eccentrically from the knurled wheel 15. Any deflection of the knurled wheel 15 out of the neutral position results in deflection of a leg of the hairpin spring 26. Hence, when the user releases the knurled wheel 15, the knurled wheel is immediately forced back into the neutral position and the motion of the intake assembly comes to a standstill.

FIG. 7 shows a perspective view (analogous to that of FIG. 2), of a grip head according to another embodiment of the invention. The control element 12 (embodied as a knurled wheel 15 in this case), is disposed on a control field 28. Control field 12 fills a lateral flank of the grip head 7 and is operated using the thumb. In accordance with the movability of the thumb, the knurled wheel 15 is rotated about an axis 16. Axis 16 extends substantially parallel to the index finger resting on the control field 10 and extends approximately in the direction of travel of the forage harvester. The exposed circumferential surface 17 of the knurled wheel is therefore be moved up and down. An upward deflection of the circumferential surface results in an upward motion of the intake assembly 2, and that a downward deflection of the circumferential surface 17 results in a downward motion of the intake assembly 2 conforms to the driver's intuition.

The following list of reference signs of various elements mentioned above is included (as follows), for ease of explanation:

### LIST OF REFERENCE CHARACTERS

1 front harvesting attachment
2 intake assembly
3 transfer bend
4 instrument panel
5 driver's cab
6 multifunctional handle
7 grip head
8 neck
9 gripping surface
10 control field
11 flank
12 control element
13 control element
14 control element
15 knurled wheel
16 axis
17 circumferential surface
18 housing segment
19 double arrow
20 leaf spring
21 projection
22 notch
23 projection
24 window
25 edge
26 hairpin spring
27 peg

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An agricultural working vehicle, comprising:
a working tool (1),
a drive assembly for raising and lowering the working tool (1), and a control element (12) that is deflected from a neutral position (0) in different directions,
wherein a speed (v) at which the drive assembly moves the working tool (1) is a continuous function of a deflection (α) of the control element (12).

2. The agricultural working vehicle according to claim 1, wherein the control element (12) is rotatable about an axis (16).

3. The agricultural working vehicle according to claim 2, wherein the control element (12) has a corrugated circumferential surface (17).

4. The agricultural working vehicle according to claim 2, wherein the axis (16) is oriented transversely to the direction of travel of the working vehicle.

5. The agricultural working vehicle according to claim 2, wherein the working tool (1) is raised upwardly, in the direction of travel via deflection of an exposed surface (17) of the control element (12) or both, and is lowered via deflection of the surface (17) opposite the direction of travel and/or downwardly.

6. The agricultural working vehicle according to claim 1, wherein the control element (12) is disposed on a multifunctional handle (6).

7. The agricultural working vehicle according to claim 6, wherein the multifunctional handle (6) comprises a gripping surface (9) oriented to support at least a portion of the palm of a driver's hand resting in an operating position and wherein the control element (12) is reachable by a finger of the hand resting in the operating position.

8. The agricultural working vehicle according to claim 7, wherein a surface (18) of the multifunctional handle (6) adjoins an exposed surface (17) of the control element (12) in a flush manner.

9. The agricultural working vehicle according to claim 1, wherein the control element is fixed in the neutral position via locking means (20, 21, 22).

10. The agricultural working vehicle according to claim 1, wherein an interval (−ε, +ε), in which the speed of the working vehicle (1) is zero, extends on either side of the neutral position (0).

11. The agricultural working vehicle according to claim 1, wherein the agricultural working machine comprises a combine harvester or a forage harvester.
